(19) United States
(12) Patent Application Publication
(10) Pub. No.: US 2022/0242610 A1
(43) Pub. Date: Aug. 4, 2022

(54) Laminated Can Sealant

(71) Applicant: Silgan Containers LLC, Woodland Hills, CA (US)

(72) Inventors: Alvin Widitora, Los Angeles, CA (US); Rowdy Holstine, Hartford, WI (US); Michael Richards, Colton, CA (US); Phil Frisella, Dunedin, FL (US)

(21) Appl. No.: 17/727,404

(22) Filed: Apr. 22, 2022

Related U.S. Application Data
(63) Continuation of application No. PCT/US2019/058129, filed on Oct. 25, 2019.

(51) Int. Cl. B65D 6/30; B65D 8/00; B32B 15/08; B32B 15/18; B32B 15/20; B21D 51/32

(52) U.S. Cl. CPC B65D 7/36; B65D 7/04; B32B 15/08; B32B 15/18; B32B 2250/40; B21D 51/32; B32B 2439/66; B32B 2250/03; B32B 15/20

(57) ABSTRACT

A metal can with a monolithic laminated hermetic seal is provided. The lid and sidewall of a can each include a laminated layer bonded to an interior surface. The lid and sidewall of the can are rolled to form a double seam and mechanically seal the can. When the double seal is formed through the mechanical rolling process and before heating, a bi-laminate layer forms between the adjacent laminated interior surfaces. The bi-laminate layer is then heated, causing each laminate layer to melt and fuse with the adjacent laminate layer. This creates a monolithic laminate layer that fills gaps within the double seam to form a hermetic seal that is impervious to air, water, gas, liquids, and other fluids.

### CROSS-REFERENCE TO RELATED PATENT APPLICATION

This application is a continuation of International Application No. PCT/US2019/058129, filed Oct. 25, 2019, which is incorporated herein by reference in its entirety.

### BACKGROUND OF THE INVENTION

The present invention relates generally to the field of laminated can including 2-piece and 3-piece metal cans. The present invention relates specifically to a seal formed on a joint between a metal sidewall and a metal lid.

### SUMMARY OF THE INVENTION

One embodiment of the invention relates to a can. The can includes a metal lid, a metal sidewall, and a double seam. The metal lid has an inside surface, an outside surface, and a flange surrounding the lid. At least the inside surface of the metal lid is bonded to a first thermoplastic laminate layer. The metal sidewall has an inside surface and an outside surface. The side wall forms a can body including an annular ridge that extends from and surrounds the sidewall. The inside surface of the sidewall is bonded to a second thermoplastic layer. The double seam is formed by rolling the flange of the lid with the annular ridge of the sidewall. The double seam includes the flange, the annular ridge, and a monolithic laminate layer formed from the portions of the laminate layers located between the flange and the annular ridge located within the double seam.

Another embodiment of the invention relates to a metal can. The metal can includes a circular metal lid, a metal sidewall, and a double hermetic seal. The circular metal lid includes an inside surface bonded to a first thermoplastic laminate layer, an outside surface, a flange surrounding the lid, a circular ridge that is concentric with the circular lid, and a countersink between the circular metal and the metal sidewall. The metal sidewall forms a can body that extends along a longitudinal axis. The sidewall includes an annular ridge extending from and surrounding the sidewall, an inside surface bonded to a second thermoplastic laminate layer, an outside surface, and a circumferential bead centered on the metal sidewall along the longitudinal axis. Rolling the flange of the lid with the annular ridge of the sidewall forms a hermetic seal in the double seam. The double seam includes the flange, the annular ridge, and a monolithic laminate layer formed from the portions of the laminate layers located between the flange and the ridge located within the double seam.

Another embodiment of the invention relates to a method of forming a double seal on a can. The method includes providing a flange on a lid with a first laminate. The method includes providing an annular ridge extending from a side wall. The annular ridge includes a second laminate. The method further comprising positioning the first laminate of the flange adjacent to the second laminate on the annular ridge and rolling the flange and the annular ridge to form a double seam. The double seam is heated until the first laminate and the second laminate form a monolithic laminate layer.

Alternative exemplary embodiments relate to other features and combinations of features as may be generally recited in the claims.

### BRIEF DESCRIPTION OF THE DRAWINGS

This application will become more fully understood from the following detailed description, taken in conjunction with the accompanying figures, wherein like reference numerals refer to like elements in which:

FIG. 1 is a cross-sectional view of a three-piece metal can with a double seam on a top and a bottom of the metal sidewall, according to an exemplary embodiment.

FIG. 2 is a cross-sectional view of a metal lid with a first laminate adjacent to a can sidewall with a second laminate before the formation of a double seam, according to an exemplary embodiment.

FIG. 3 is a cross-sectional view of a metal lid with a first laminate adjacent to a can sidewall with a second laminate during the formation process of a double seam, according to an exemplary embodiment.

FIG. 4 is a cross-sectional view of a metal lid with a first laminate adjacent to a can sidewall with a second laminate following the formation of a double seam with a laminate bi-layer, according to an exemplary embodiment.

FIG. 5 is a cross-sectional view of a metal lid with a first laminate coupled to a can sidewall with a second laminate and a formed double seam with a monolithic laminate seal, according to an exemplary embodiment.

FIG. 6 is a perspective view of the double seam formed from the metal can lid joined to a can sidewall of the can body, according to an exemplary embodiment.

FIG. 7 is a side view of the sidewall of the can body, according to an exemplary embodiment.

FIG. 8 is a top view of the metal can lid, according to an exemplary embodiment.

FIG. 9 is a cross-sectional view of the monolithic bond formed from a 100° C. melting and fusing process, according to an exemplary embodiment.

FIG. 10 is a cross-sectional view of the monolithic bond formed from a 102° C. melting and fusing process, according to an exemplary embodiment.

FIG. 11 is a cross-sectional view of the monolithic bond formed from a 104° C. melting and fusing process, according to an exemplary embodiment.

FIG. 12 is a cross-sectional view of the monolithic bond formed from a 106° C. melting and fusing process, according to an exemplary embodiment.

FIG. 13 is a cross-sectional view of the monolithic bond formed from a 108° C. melting and fusing process, according to an exemplary embodiment.

FIG. 14 is a method of creating a hermetic seal at a double seam, according to an exemplary embodiment.

### DETAILED DESCRIPTION

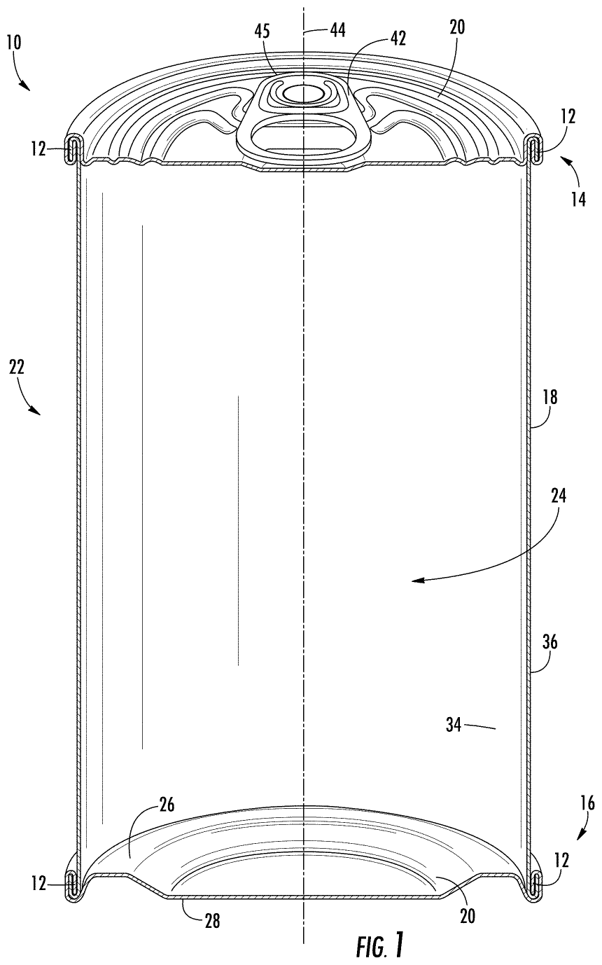

FIG. 1 is a cross-sectional view of one embodiment of a three-piece metal can 10 with a double seam 12 on a top 14 and a bottom 16 of a metal sidewall 18. In some embodiments, one or more components of can 10 include metal, such as steel, tin plate, and/or an aluminum alloy. Sidewall 18 couples to a circular lid or can end 20 on the top 14 and/or bottom 16 of can 10. Can body 22 forms from the coupled sidewall 18 and can end(s) 20 and defines a can interior or volume 24. Forming double seam 12 seals volume 24 from the external environment hermetically.

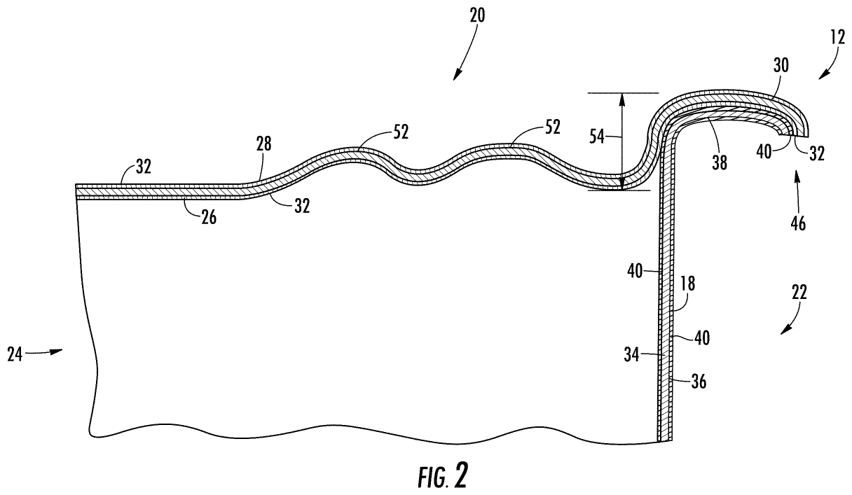

Each can end 20 has an inside surface 26, an outside surface 28, and a flange, e.g., “lid flange 30” (FIGS. 2-5) surrounding can end 20. FIG. 1 illustrates inside surface 26, and outside surface 28 on a bottom 16 can end 20; however, the same or similar inside surface 26 and outside surface 28 exist on top 14 of can end 20. At least the inside surface 26 of can end 20 is bonded to a first thermoplastic laminate layer or end laminate 32 (FIGS. 2-5). Similarly, sidewall 18 has an inside surface 34 and an outside surface 36. Sidewall 18 couples to can end(s) 20 to form can body 22. An annular ridge or sidewall flange 38 extends from and surrounds sidewall 18 (FIGS. 2-5). At least the inside surface 34 bonds to a second thermoplastic layer or sidewall laminate 40.

In some embodiments, can end 20 includes a pull-tab, a resealable metal foil, an opener, or tab 42. Tab 42 facilitates opening can 10. Can end 20 may further include a score 45 that has a thickness that is less than can end 20. Tab 42 and score 45 cooperate to depress tab 42 through score 45 to open can end 20. In other embodiments, an external tool (e.g., can opener) is used to open double seam 12 and/or can end 20 on can 10.

Sidewall 18 extends along a longitudinal axis 44 of can body 22. Stated differently, longitudinal axis 44 extends axially through a centerline of sidewall 18. Can 10 may be a three-piece can 10 with two can ends 20 and a sidewall 18 or a two-piece can 10. For example, a two-piece can body 22 is drawn from a single sheet of material and has an integral seamless bottom 16 coupled to can end 20 on the top 14 of can 10.

In some embodiments, can 10 is a three-piece can (as shown in FIG. 1) and includes a metal bottom 16. Bottom 16 includes a can end 20 with inside surface 26 and outside surface 28 and lid flange 30. The bottom 16 inside surface 26 bonds to a third thermoplastic laminate layer, the same as or similar to end laminate 32. In this configuration, lid flange 30 surrounds the bottom 16 of can end 20 and the bottom 16 sidewall flange 38 extends from and surrounds the bottom 16 of sidewall 18.

FIGS. 2-5 illustrate a general process to form double seam 12, according to an exemplary embodiment. Rolling lid flange 30 of can end 20 with sidewall flange 38 of sidewall 18 forms double seam 12. The intermediate rolled double seam 12 includes lid flange 30, sidewall flange 38, and bi-laminate layer 46 formed from end laminate 32 and sidewall laminate 40. Bi-laminate layer 46 is then heated to form a monolithic laminate 48 (e.g., a monolithic laminate layer). Portions of end laminate 32 and sidewall laminate 40 located between lid flange 30 and sidewall flange 38 melt and fuse together to form monolithic laminate 48. The resulting monolithic laminate 48 is located within double seam 12 and forms a hermetic seal that is impervious to liquid and/or gas. For example, the heating and rolling processes on the three-piece can of FIG. 1, squeeze the fused monolithic laminate 48 into any gaps 50 formed between lid flange 30 and sidewall flange 38. Double seams 12 form on the top 14 and bottom 16 of the three-piece can 10 that includes a heated and fused monolithic laminate 48.

FIG. 2 is a cross-sectional view of can end 20 with end laminate 32 adjacent to sidewall 18 with sidewall laminate 40 before the rolling formation of double seam 12. As shown, end laminate 32 extends along lid flange 30 and sidewall laminate 40 extends along sidewall flange 38 to form an unrolled bi-laminate layer 46. In some embodiments, at least one of the thermoplastic laminates (e.g., end laminate 32 or sidewall laminate 40) is selected from a polymer laminate.

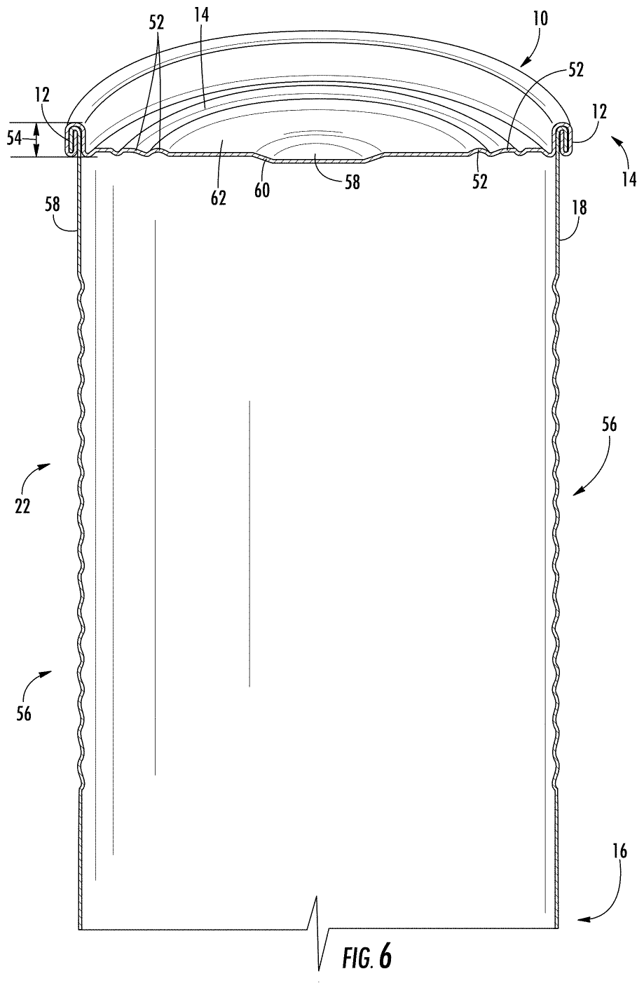

In some embodiments, can end 20 includes one or more circular ridges 52 that are concentric with the circular can end 20. As discussed below concerning FIG. 6, can 10 may further include a countersink 54 between can end 20 and sidewall 18.

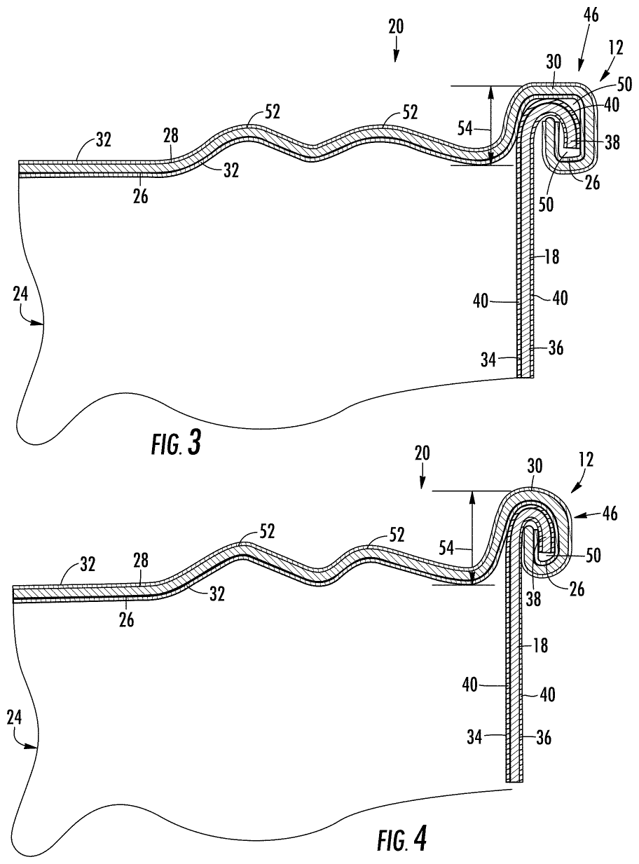

FIG. 3 is a cross-sectional view of can end 20 with end laminate 32 adjacent to sidewall laminate 40 during the double seam 12 formation process. Double seam 12 is formed by folding lid flange 30 with a first laminate or end laminate 32 and sidewall flange 38 with a second laminate or sidewall laminate 40. During the process, the end laminate 32 separates from the sidewall laminate 40 and forms various gaps 50. Double seam 12 is pressed, rolled, and subject to other mechanical seaming forces to force the lid flange 30 and sidewall flange 38 together. The rolling (e.g., pressing, ironing, compressing, flattening, and/or using mechanical forces to compress) compresses end laminate 32 against sidewall laminate 40 creating a bi-laminate layer 46 with relatively fewer gaps 50, as shown in FIG. 4.

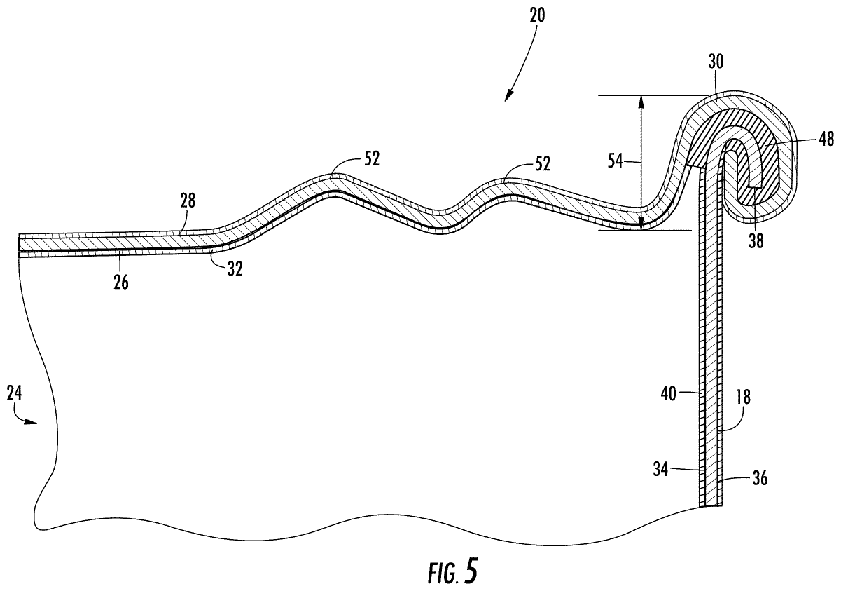

FIG. 4 shows the lid flange 30 and sidewall flange 38 after the pressing or rolling process but before the heating process. In this configuration, double seam 12 includes bi-laminate layer 46 with persistent gaps 50 formed during the mechanical rolling process. Lid flange 30 is bonded to end laminate 32 and is immediately adjacent to sidewall laminate 40 of sidewall flange 38. Lid flange 30, end laminate 32, sidewall laminate 40, and sidewall flange 38 form a compressed double seam 12 with a rolled bi-laminate layer 46 (e.g., before heating and fusing double seam 12). The heating process converts bi-laminate layer 46 of FIG. 4 to a monolithic laminate layer that cools to form the fused monolithic laminate 48 shown in FIG. 5. Monolithic laminate 48 creates a hermetic seal between volume 24 and the environment. For example, the hermetic seal may be impervious to air, water, gas, liquid, and/or other fluids.

FIG. 5 shows the resulting monolithic laminate 48 formed between lid flange 30 and sidewall flange 38 after the heating and fusing process. Bi-laminate layer 46 is heated to melt and fuse end laminate 32 with sidewall laminate 40 to form the new monolithic laminate 48. Monolithic laminate 48 aids in the formation of the hermetic seal by filling any gaps 50 that might otherwise exist between the folded metal material of lid flange 30 and sidewall flange 38. Monolithic laminate 48 is an amalgam of end laminate 32 and sidewall laminate 40 that are compressed and heated to transform bi-laminate layer 46 to monolithic laminate 48. The compression forces and heat forces and squeezes monolithic laminate 48 to flow into any existing gaps 50 between lid flange 30 and sidewall flange 38 to form a hermetic seal.

In an exemplary embodiment, double seam 12 is formed using a can seaming machine (e.g., a seamer, double seamer, closing machine, etc.). In some embodiments, the seaming machine includes a heater (e.g., induction heater) to focus heat on bi-laminate layer 46 to form monolithic laminate 48 (e.g., from 100° C. to 110° C.). In other embodiments, the heater is a standalone device that independently heats double seam 12 after the seamer has pressed the lid flange 30 and sidewall flange 38 together.

The seaming machine may include a base plate and a chuck. Sidewall 18 and can end 20 are held in place adjacent to each other by a load applied vertically through the base plate. The formation of double seam 12 can take place in two or more steps. For example, double seam 12 is formed using a seaming machine that holds sidewall 18 and can end 20 stationary on the chuck while seaming rolls revolve around sidewall 18 and can end 20 to form double seam 12. In a second style, seaming machine holds sidewall 18 and can end 20 between a rotating chuck and base plate, which rotates sidewall 18 and can end 20 to form double seam 12.

The heater may be incorporated into the seaming machine or may be a separate standalone device. In some embodiments, an induction heater melts bi-laminate layer 46 to form monolithic laminate 48. For example, induction heater is a 10 kW, 150-400 kHz solid state induction power supplied heater equipped with a remote heat station containing two 0.5 μF capacitors in series to create a total capacitance of 0.25 μF. Induction heater may include a single position channel coil. For example, can 10 rotates at 10 rpm under the high current channel coil of an induction heater. The monolithic laminate 48 hermetic seal is formed by heating metal can end 20 and metal sidewall 18 under the channel coil to temperatures between 80° C. and 120° C. For example, the channel coil heats bi-laminate layer 46 to form monolithic laminate 48 in double seam 12 to a temperature between 85° C. and 115° C., specifically between 90° C. and 110° C., and more specifically between 100° C. and 110° C. The heater can heat double seam 12 to a temperature of 100° C. in a time between 1 second and 5 seconds, specifically between 2 seconds and 4 seconds.

Sidewall 18 and one or more can ends 20 form can body 22. Can 10 may be used to hold perishable materials (e.g., food). It should be understood that the phrase “food” used to describe various embodiments of this disclosure may refer to dry food, moist food, powder, liquid, or any other drinkable or edible material, regardless of nutritional value. In other embodiments, can ends 20 on top 14 and/or bottom 16 of can 10 as discussed herein may be on containers used to hold non-perishable materials or non-food materials. In various embodiments, can ends 20 discussed herein may be on containers that the product is packed in liquid form and is drained from the product before use. For example, the containers discussed herein may contain vegetables, pasta or meats packed in a liquid such as water, brine, or oil.

FIG. 6 is a perspective view of can 10 with double seam 12 formed from can end 20 joined to sidewall 18 to form can body 22. In some embodiments, can 10 sidewall 18 includes a plurality of circumferential beads 56 and/or a flat cylindrical panel 57. For example, flat cylindrical panel 57 may interconnect circumferential beads 56 to sidewall flange 38 that forms double seam 12 at the top 14 or bottom 16 pf can end 20. As shown in FIG. 6, one or more circumferential beads 56 are centered along longitudinal axis 44 of sidewall 18.

As illustrated in FIG. 6, top 14 (and/or bottom 16) includes a flat inner portion 58, one or more bends or transitions 60, and a flat central portion 62. Circular ridges 52 extend radially about flat inner portion 58 and/or flat central portion 62. Circular ridges 52 are a type of transition 60 that enable can end 20 to expand or retract when loaded either thermally or mechanically. For example, thermal or mechanical pressures applied to can body 22 expand can end 20 at circular ridges 52 and/or transitions 60. Similarly, thermal pressures generated from heating can 10 (e.g., to form monolithic laminate 48 and/or to cook food within volume 24), generate thermos mechanical stresses that are relieved at circular ridges 52 and/or transitions 60.

Beads 56 act to strengthen sidewall 18 against radial loads that may occur due to the internal vacuum generated in can 10, by the grip of a person holding can 10, and/or other external forces (e.g., transport and storage). In various embodiments, can 10 is configured to hold contents at an internal vacuum of at least 28 pounds/square inch (gauge) or “psig,” and in another embodiment, can 10 is configured to hold contents at an internal vacuum of at least 22 psig. In other embodiments, food located with the internal cavity or interior volume 24 fills can 10. Can 10 has an internal vacuum of at least 22 psig and/or at least 28 psig when sealed beads 56 strengthen sidewall 18 against radial inward forces resulting from the internal vacuum.

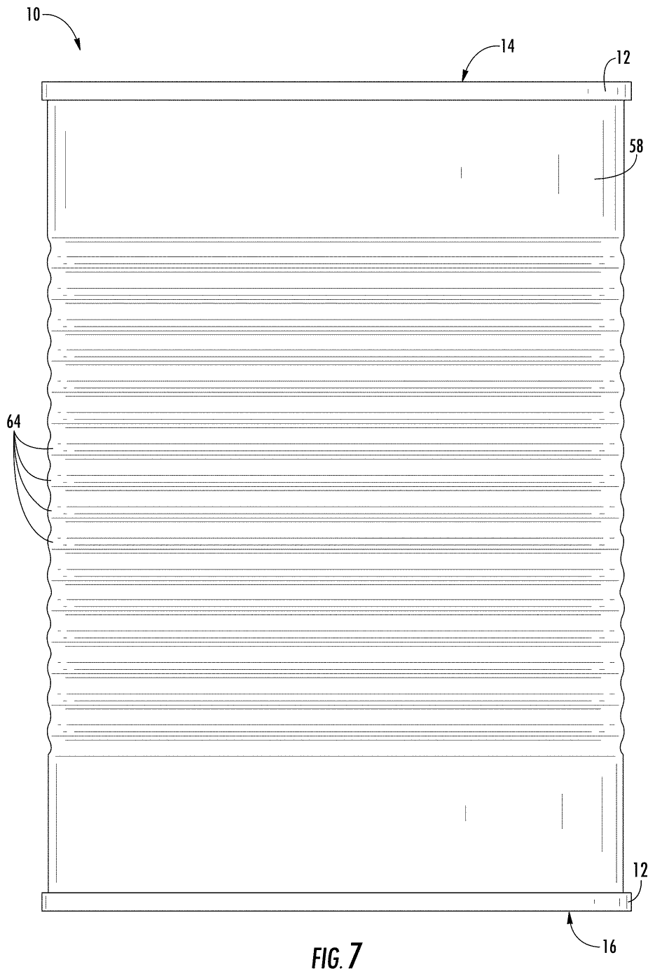

A plurality of circumferential beads 56 in cylindrical sidewall 18 can form a bead panel 64 (FIG. 7). In various embodiments, bead panel 64 encompasses at least 30%, 35%, 40%, 45%, 50%, 55%, 60% or more of an axial length of the cylindrical sidewall 18. Expected design mechanical and/or thermal stresses on can 10 adjust the proportion of bead panel 64 to the length of sidewall 18. For example, a larger design load (e.g., mechanical or thermal load) results in a higher percentage of sidewall 18 with bead panels 64. Bead panel 64 can be formed on any part of sidewall 18. For example, a first bead panel 64 and second bead panel 64 may be separated by a flat cylindrical panel 57 in the center of sidewall 18.

FIG. 7 illustrates an exemplary can 10 that includes a bead panel 64 of circumferential beads 56 formed in sidewall 18. Generally, each bead 56 is a radially outwardly extending curved surface that extends radially outward relative to sidewall 18. In various embodiments, can 10 includes at least two circumferential beads 56 including at least one bead 56 located in the center portion and at least one bead 56 located in an upper portion (e.g., nearer top 14) and/or in a lower portion (e.g., nearer bottom 16).

In various embodiments, sidewall 18 includes metal(s) of various thicknesses, and beads 56 are selected to strength non-cylindrical sidewall 18 against the radial inward force that results from the internal vacuum for the various thicknesses. According to various exemplary embodiments, sidewall 18 is formed from steel having a working gauge range from about 0.0045 inches thick to about 0.020 inches thick. In other embodiments, sidewall 18 and/or can end 20 include tin, steel, or aluminum with thicknesses between 0.045 inches and 0.010 inches thick.

In various embodiments, can end 20 includes comprises at least three circular ridges 52 and a countersink depth 54 between 0.120″ and 0.250″. The seal thickness or thickness of can end 20 is between 0.0225″ and 0.100″. Circular ridges 52 are between ⅛″ and ½″ inches, measured from one valley to the adjacent valley of the circular ridges 52, or similarly, from one peak to the adjacent peak of the circular ridges 52.

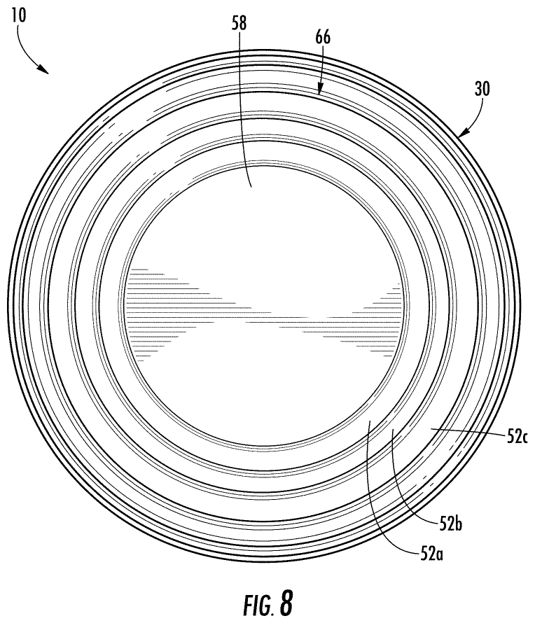

Referring now to FIG. 8, a top view of an isolated can end 20 is shown, according to an exemplary embodiment. Can end 20 includes lid outer curl 30, annular rigid portion 66 (e.g., forming one or more circular ridges 52), and a flat inner portion 58. Can end 20 is formed from a blank piece of steel stock having a first diameter that is stretched and/or tooled such that the finished diameter of can end 20 is greater than the first diameter. In one embodiment, the first diameter is greater than 6.5 inches and the second diameter is greater than 6.750 inches. The total surface area of can end 20 is between 35.0 and 36.0 square inches. In another embodiment, the total surface area of can end 20 is 35.784 square inches.

Lid flange 30 is contiguous with and extends radially from rigid annular portion 66 having one or more circular ridges 52. Lid flange 30 extends from and surrounds rigid portion 66. Lid flange 30 has a surface area between 33 and 34 percent of the total surface area and preferably between 33.2 and 33.8 percent of the total surface area. In one embodiment, lid flange 30 has a surface area of 12.026 square inches or at least 33 percent of the total surface area and preferably at least 33.6 percent of the total area.

As illustrated, rigid portion 66 has a first ridge 52a, a second ridge 52b, and a third ridge 52c. Ridges 52a, 52b, and 52c relieve physical and/or thermal stresses on can end 20 resulting from external thermal or mechanical forces (applied pressure and/or heat) and relieve stresses applied to the joined can end 20 and/or double seam 12. Ridges 52a, 52b, and 52c act as a bellows for easier expansion and contraction of can end 20. Additional embodiments are contemplated that have more or fewer ridges 52 (e.g., 52a, 52b, 52c, 52d, 52e, 52f, etc.). Rigid portion 66 is integral and contiguous with both lid flange 30 and flat inner portion 58. Rigid portion 66 extends radially outwardly to surround flat inner portion 58 and extends inwardly from lid flange 30. In various embodiments, rigid portion 66 has a surface area between 42% and 43% of the total surface area, specifically between 42.1% and 42.5% of the total surface area. Rigid portion 66 has a surface area of 15.135 square inches or at least 42% of the total surface area, specifically at least 42.3% of the total surface area.

In various embodiments, inner portion 58 has a surface area between 23 and 25 percent of the total surface area and preferably between 23.9 and 24.3 percent of the total surface area. In one embodiment, inner portion 58 has a surface area of 8.625 square inches or at least 24% of the total surface area, specifically at least 24.1% of the total surface area. In another embodiment, flat inner portion 58 is substantially non-planar.

FIG. 9-13 illustrate the results of a laminate bonding agent to create and enhance the hermetic seal of a double seam. Using induction, focused heat is applied to the double seam area to melt the polymer layers and recrystallize when cooled to form a solid monolithic layer. In the illustrated embodiment, five temperature variables for a 401×204 can were tested with polymer laminates on the exterior and interior of the can surfaces.

The double seam formed at each temperature was cross-sectioned and prepared using standard metallographic techniques. The cross-sectioned samples were examined to determine if the coatings had bonded to form a hermetic seal in the monolithic layer.

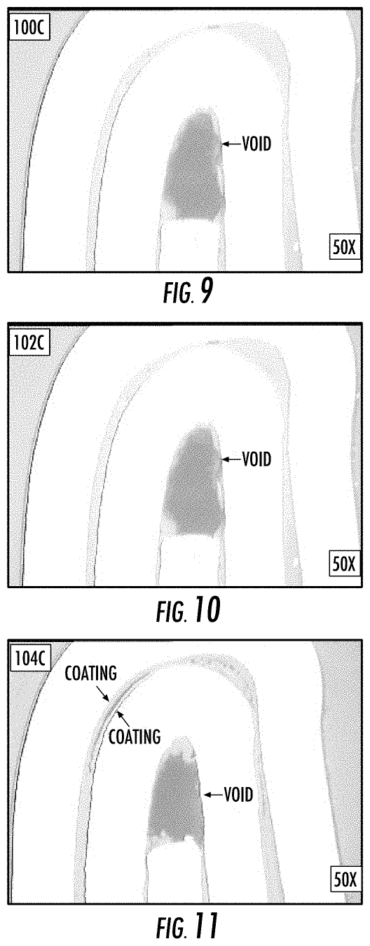

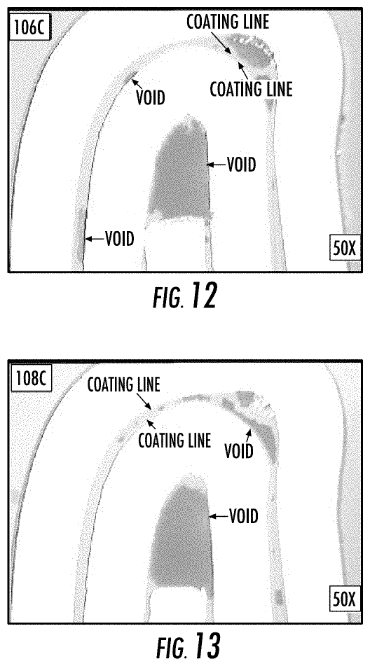

FIG. 9 illustrates the resulting seam formed from a test temperature of 100° C. FIG. 10 illustrates the resulting seam formed from a test temperature of 102° C. FIG. 11 illustrates the resulting seam formed from a test temperature of 104° C. FIG. 12 illustrates the resulting seam formed from a test temperature of 106° C. FIG. 13 illustrates the resulting seam formed from a test temperature of 108° C. At all temperatures tested, the seal integrity adequately formed a monolithic laminate 48 layer to seal double seam 12 of can 10 hermetically. For example, the resulting monolithic laminate 48 formed a hermetic seal against a dye leak path.

With reference to FIGS. 9-13, cans 10 with a monolithic laminate 48 formed at each temperature range were air leak tested at 18 psig. At the pressure, cans 10 passed without an air leak path. The cans 10 with a monolithic laminate 48 formed at each temperature range were dried, and zyglo dye-leak tested at 20″ Hg vacuum for 4 hours. Under those conditions, the cans 10 passed without the formation of a dye-leak path through the double seam 12.

The double seam formed at each temperature was cross-sectioned in three different places an evaluated for seam impression. Specifically, evaluation of double seam 12 occurred in three leak locations for the cover hook, the body hook, and an overlap. The double seam impression was light to not visible on all tested areas for each temperature tested. Table 1 summarizes the test results.

TABLE 1

| Variable | Cover Hook | | | Body Hook | | | Overlap | | |
|---|---|---|---|---|---|---|---|---|---|
| 100° C. | 0.0797 | 0.0791 | 0.0754 | 0.0777 | 0.0816 | 0.0802 | 0.0569 | 0.0585 | 0.0558 |
| 102° C. | 0.0734 | 0.0782 | 0.0796 | 0.0787 | 0.0801 | 0.0822 | 0.0537 | 0.0577 | 0.0595 |
| 104° C. | 0.0776 | 0.0790 | 0.0767 | 0.0811 | 0.0795 | 0.0821 | 0.0561 | 0.0567 | 0.0586 |
| 106° C. | 0.0776 | 0.0706 | 0.0821 | 0.0787 | 0.0778 | 0.0843 | 0.0577 | 0.0531 | 0.0627 |
| 108° C. | 0.0777 | 0.0793 | 0.0764 | 0.0792 | 0.0815 | 0.0795 | 0.0565 | 0.0584 | 0.0531 |

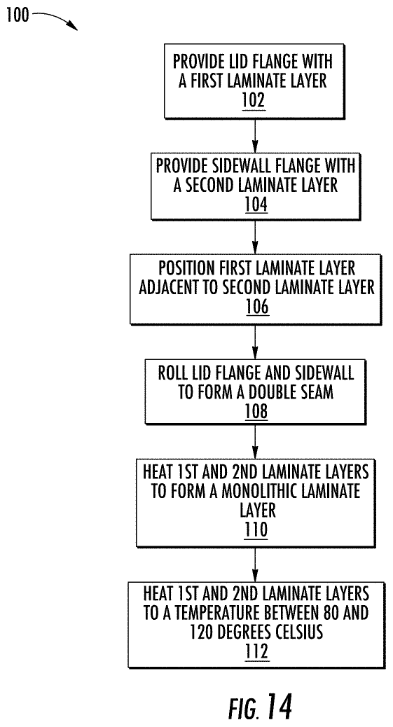

FIG. 14 illustrates a method 100 of forming a seal or double seam 12 on can 10. Method 100 involves a first step 102 of providing or forming lid flange 30 on can end 20. Can end 20 and lid flange 30 include an end laminate 32. A second step 104 provides an annular ridge or sidewall flange 38 that extends from sidewall 18. Sidewall 18 and sidewall flange 38 include a sidewall laminate 40. A third step 106 of method 100, positions the end laminate 32 of lid flange 30 adjacent to the sidewall laminate 40 of sidewall flange 38. A fourth step 108 rolls lid flange 30 about sidewall flange 38 to form double seam 12 with a bi-laminate layer 46. A fifth step 110 heats bi-laminate layer 46 (e.g., end laminate 32 and sidewall laminate 40) to form and fuse a new monolithic laminate 48. A sixth optional or alternative step 112, heats metal can end 20 between temperatures of 80° C. and 120° C., to form a monolithic laminate 48 that provides a hermetic seal between lid flange 30 and metal sidewall 18.

It should be understood that the figures illustrate the exemplary embodiments in detail, and it should be understood that the present application is not limited to the details or methodology set forth in the description or illustrated in the figures. It should also be understood that the terminology is for the purpose of description only and should not be regarded as limiting.

Further modifications and alternative embodiments of various aspects of the invention will be apparent to those skilled in the art in view of this description. Accordingly, this description is to be construed as illustrative only. The construction and arrangements, shown in the various exemplary embodiments, are illustrative only. Although only a few embodiments have been described in detail in this disclosure, many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter described herein. Some elements shown as integrally formed may be constructed of multiple parts or elements, the position of elements may be reversed or otherwise varied, and the nature or number of discrete elements or positions may be altered or varied. The order or sequence of any process, logical algorithm, or method steps may be varied or re-sequenced according to alternative embodiments. Other substitutions, modifications, changes, and omissions may also be made in the design, operating conditions and arrangement of the various exemplary embodiments without departing from the scope of the present invention.

For purposes of this disclosure, the term “coupled” means the joining of two components directly or indirectly to one another. Such joining may be stationary in nature or movable in nature. Such joining may be achieved with the two members and any additional intermediate members being integrally formed as a single unitary body with one another or with the two members or the two members and any additional member being attached to one another. Such joining may be permanent in nature or alternatively may be removable or releasable in nature.

While the current application recites particular combinations of features in the claims appended hereto, various embodiments of the invention relate to any combination of any of the features described herein whether or not such combination is currently claimed, and any such combination of features may be claimed in this or future applications. Any of the features, elements, or components of any of the exemplary embodiments discussed above may be used alone or in combination with any of the features, elements, or components of any of the other embodiments discussed above.

In various exemplary embodiments, the relative dimensions, including angles, lengths, and radii, as shown in the Figures are to scale. Actual measurements of the Figures will disclose relative dimensions, angles, and proportions of the various exemplary embodiments. Various exemplary embodiments extend to various ranges around the absolute and relative dimensions, angles and proportions that may be determined from the Figures. Various exemplary embodiments include any combination of one or more relative dimensions or angles that may be determined from the Figures. Further, actual dimensions not expressly set out in this description can be determined by using the ratios of dimensions measured in the Figures in combination with the express dimensions set out in this description.

According to exemplary embodiments, the containers, and specifically the container sidewalls, discussed herein are formed from metal, and specifically may be formed from, stainless steel, tin-coated steel, aluminum, etc. In some embodiments, the containers discussed herein are formed from aluminum, and the can ends are formed from tin-coated steel. In some embodiments, the sidewall of the container is formed from a metal material, and other metals or materials (e.g., polymers, high-temperature plastic, thermoplastics, cardboard, ceramic, etc.) are used to form the end walls of the container.

Containers discussed herein may include containers of any style, shape, size, etc. For example, the containers discussed herein may be shaped such that cross-sections taken perpendicular to the longitudinal axis of the container are generally circular. However, in other embodiments, the sidewall of the containers discussed herein may be shaped in a variety of ways (e.g., having other non-polygonal cross-sections, as a rectangular prism, a polygonal prism, any number of irregular shapes, etc.) as may be desirable for different applications or aesthetic reasons. In various embodiments, the sidewall of can 10 may include one or more axially extending sidewall sections that are curved radially inwardly or outwardly such that the diameter of the can is different at different places along the axial length of the can, and such curved sections may be smooth continuous curved sections. In one embodiment, can 10 may be hourglass shaped. Can 10 may be of various sizes (e.g., 3 oz., 8 oz., 12 oz., 15 oz., 28 oz, etc.) as desired for a particular application.

Further, a container may include a container end (e.g., a closure, lid, cap, cover, top, end, can end 20, sanitary end, “pop-top”, “pull top”, convenience end, convenience lid, pull-off end, easy open end 20, “EZO” end, etc.). The container end may be any element that allows the container to be sealed such that the container is capable of maintaining a hermetic seal. In an exemplary embodiment, the upper can end may be an “EZO” convenience end, sold under the trademark “Quick Top” by Silgan Containers Corp.

The upper and lower can ends discussed above are shown coupled to the can body via a “double seam” formed from the interlocked portions of material of the can sidewall and the can end. However, in other embodiments, the can ends discussed herein may be coupled to the sidewall via other mechanisms. For example, can ends 20 may be coupled to the sidewall via welds or solders. As shown above, the containers discussed herein are three-piece cans having an upper can end, a lower can end and a sidewall each formed from a separate piece of material. However, in other embodiments, can 10 may be a two-piece can (i.e., a can including a sidewall and an end wall that are integrally formed and a separate can end component joined to the sidewall via a double seam).

In various embodiments, the upper can end may be a closure or lid attached to the body sidewall mechanically (e.g., snap on/off closures, twist on/off closures, tamper-proof closures, snap on/twist off closures, etc.). In another embodiment, the upper can end 20 may be coupled to the container body via the pressure differential. The container end may be made of metals, such as steel or aluminum, metal foil, plastics, composites, or combinations of these materials. In various embodiments, the can ends 20, double seams 12, and sidewall 18 of the container are adapted to maintain a hermetic seal after the container is filled and sealed.

The containers discussed herein may be used to hold perishable materials (e.g., food, drink, pet food, milk-based products, etc.). It should be understood that the phrase “food” used to describe various embodiments of this disclosure may refer to dry food, moist food, powder, liquid, or any other drinkable or edible material, regardless of nutritional value. In other embodiments, the containers discussed herein may be used to hold non-perishable materials or non-food materials. In various embodiments, the containers discussed herein may contain a product that is packed in a liquid that is drained from the product before use. For example, the containers discussed herein may contain vegetables, pasta or meats packed in a liquid such as water, brine, or oil.

During certain processes, containers are filled with hot, pre-cooked food then sealed for later consumption, commonly referred to as a “hot fill process.” As the contents of the container cool, the pressure within the sealed container decreases such that there is a pressure differential (i.e., internal vacuum) between the interior of the container and the exterior environment. This pressure difference results in an inwardly directed force being exerted on the sidewall of the container and the end walls of the container. In embodiments using a vacuum attached closure, the resulting pressure differential may partially or completely secure the closure to the body of the container. During other processes, containers are filled with uncooked food and are then sealed. The food is then cooked to the point of being commercially sterilized or “shelf stable” while in the sealed container. During such a process, the required heat and pressure may be delivered by a pressurized heating device or retort.

According to various exemplary embodiments, the inner surfaces of the upper and lower can ends, and the sidewall may include a laminated layer or liner (e.g., an insert, coating, lining, a protective coating, sealant, etc.). The protective coating acts to protect the material of the container from degradation that may be caused by the contents of the container. In an exemplary embodiment, the protective coating may be a coating that may be applied via spraying or any other suitable method. Different coatings may be provided for different food applications. For example, the liner or coating may be selected to protect the material of the container from acidic contents, such as carbonated beverages, tomatoes, tomato pastes/sauces, etc. The coating material may be a vinyl, polyester, epoxy, EVOH and/or other suitable lining material or spray. The interior surfaces of the container ends may also be coated with a protective coating as described above.

What is claimed is:

1. A can, comprising:
a metal lid having an inside surface, an outside surface, and a flange surrounding the lid, at least the inside surface being bonded to a first thermoplastic laminate layer;
a metal sidewall having an inside surface, and an outside surface and, the side wall forming a can body comprising an annular ridge extending from and surrounding the sidewall, the inside surface being bonded to a second thermoplastic layer; and
a double seam formed by rolling the flange of the lid with the annular ridge of the sidewall, the double seam including the flange, the annular ridge, and a monolithic laminate layer formed from the portions of the laminate layers located between the flange and the annular ridge located within the double seam.

2. The can of claim 1, wherein the monolithic laminate layer is formed by heating the double seam.

3. The can of claim 1, wherein the can body is drawn from a single sheet of material and has an integral seamless bottom.

4. The can of claim 1, wherein the metal is steel.

5. The can of claim 1, wherein the metal is tin plate.

6. The can of claim 1, wherein the metal is an aluminum alloy.

7. The can of claim 1, further comprising:
a metal bottom having an inside surface, an outside surface, and a flange surrounding the bottom, at least the inside surface being bonded to a third thermoplastic laminate layer,
a bottom annular ridge extending from and surrounding the bottom of the side wall of the can body; and
a bottom double seam formed by rolling the flange of the bottom with the bottom annular ridge of the sidewall, the double seam including the bottom flange, the bottom annular ridge, and a bottom monolithic laminate layer formed from the portions of the laminate layers located between the bottom flange and the bottom ridge located within the double seam.

8. The can of claim 7, wherein the bottom monolithic laminate layer is formed by heating the bottom double seam.

9. A metal can, comprising:
a circular metal lid, comprising:
an inside surface bonded to a first thermoplastic laminate layer;
an outside surface;
a flange surrounding the lid;
a circular ridge that is concentric with the circular lid; and
a countersink between the circular metal and the metal sidewall,
a metal sidewall forming a can body extending along a longitudinal axis, the sidewall comprising:
an annular ridge extending from and surrounding the sidewall,
an inside surface bonded to a second thermoplastic laminate layer;
an outside surface; and
a circumferential bead centered on the metal sidewall along the longitudinal axis; and
a double hermetic seal formed by rolling the flange of the lid with the annular ridge of the sidewall, the double seam including the flange, the annular ridge, and a monolithic laminate layer formed from the portions of the laminate layers located between the flange and the ridge located within the double seam.

10. The can of claim 9, wherein the hermetic seal is formed by heating the metal lid and the metal sidewall monolithic layer between 80° C. and 120° C.

11. The can of claim 9, further comprising a second double hermetic seal formed by rolling a second flange of a second lid, wherein the second double hermetic seal includes the second flange and the second lid.

12. The can of claim 9, wherein the circular lid comprises at least three ridges, a countersink depth between 0.120″ and 0.250″ and a seal thickness between 0.0225″ and 0.100″.

13. The can of claim 9, wherein the ridge is between ⅛″ and ½″ inches.

14. The can of claim 9, further comprising a plurality of circumferential beads in the cylindrical sidewall forming a bead panel, wherein the bead panel encompasses at least 30% of an axial length of the cylindrical sidewall.

15. The can of claim 9, further comprising a pull-tab on the lid, the lid further including a score that has a thickness that is less than the lid, the pull-tab and score configured to cooperate to depress the pull-tab through the score to open the lid.

16. The can of claim 9, wherein the lid is thicker than the metal sidewall.

17. The can of claim 9, further comprising:
a metal bottom having an inside surface bonded to a third thermoplastic laminate layer, an outside surface, and a flange surrounding the bottom, a circular ridge that is concentric with the bottom, and a countersink between the bottom and the sidewall,
a bottom annular ridge extending from and surrounding sidewall; and
a bottom double hermetic seal formed by rolling the flange of the bottom with the bottom annular ridge of the sidewall, the double hermetic seal including the bottom flange, the bottom annular ridge, and a bottom monolithic laminate layer formed from the portions of the laminate layers located between the bottom flange and the bottom ridge located within the double seam.

18. The can of claim 17, wherein the bottom monolithic laminate layer is formed by heating the bottom double seam.

19. A method of forming a double seal on a can, the method comprising:
providing a flange on a lid comprising a first laminate;
providing an annular ridge extending from a side wall, the annular ridge comprising a second laminate;
positioning the first laminate of the flange adjacent to the second laminate on the annular ridge;
rolling the flange and the annular ridge to form a double seam; and
heating the first laminate and the second laminate to form a monolithic laminate layer.

20. The method of claim 19, further comprising rotating the double seam under a high current channel coil.
